(19) United States
(12) Patent Application Publication
(10) Pub. No.: US 2026/0296461 A1
(43) Pub. Date: Oct. 1, 2026

(54) SYSTEMS AND METHODS FOR AUTONOMOUS VEHICLE TEST ORDER GENERATION

(71) Applicant: AVRIDE Inc., Newburyport, MA (US)

(72) Inventors: Dmitriy Baranov, Tel Aviv (IL); Roman Udovichenko, Austin, TX (US)

(21) Appl. No.: 19/578,458

(22) Filed: Mar. 25, 2026

Related U.S. Application Data
(60) Provisional application No. 63/777,161, filed on Mar. 25, 2025.

(51) Int. Cl. B60W 50/04; B60W 50/00; B60W 60/00; G01C 21/34

(52) U.S. Cl. CPC B60W 50/045; B60W 60/001; G01C 21/3423; G01C 21/343; B60W 2050/0052; B60W 2050/046; B60W 2556/40

(57) ABSTRACT

Provided herein is a system and method for autonomous vehicle test order generation, the system including: at least one processor; and a memory communicatively connected to the at least one processor, the memory containing instructions configuring the at least one processor to: receive a pool of waypoints; generate a test order, wherein generating the test order includes: selecting at least two waypoints from the pool of waypoints; and determining a feasibility metric for the at least two waypoints, wherein determining the feasibility metric includes using a route generation algorithm to generate a route between the at least two waypoints; select a test vehicle from a fleet of test vehicles; and transmit the test order to the test vehicle.

### CROSS REFERENCE TO RELATED APPLICATIONS

This application claims the benefit of priority to U.S. Provisional Application No. 63/777,161, filed on Mar. 25, 2025 and entitled “AUTONOMOUS VEHICLE TEST ORDER GENERATION AND MANAGEMENT SYSTEM,” the entirety of which is incorporated herein by reference.

### FIELD OF THE INVENTION

The present invention is directed generally to vehicle testing. Particularly, the present invention is directed to systems and methods for autonomous vehicle test order generation.

### BACKGROUND OF THE INVENTION

Historically, common methods of testing of autonomous vehicle fleets use scenarios for autonomous vehicles operating in a test environment. However, the common testing of autonomous vehicle fleets employed historically fails to provide real-life conditions and scenarios with simulated orders which evidences a disadvantage in the quality assurance and system reliability of commonly used testing of autonomous vehicle fleets.

Therefore, the need exists for a system that ensures holistic testing of autonomous vehicle systems under conditions that closely approximate real-world operations, significantly enhancing quality assurance processes and system reliability.

Accordingly, there remains a need in the art for systems and methods that improve upon existing system and methods for autonomous vehicle testing. The present disclosure meets this need.

### SUMMARY

In some aspects, the techniques described herein relate to a system for autonomous vehicle test order generation, the system including: at least one processor; and a memory communicatively connected to the at least one processor, the memory containing instructions configuring the at least one processor to: receive a pool of waypoints; generate a test order, wherein generating the test order includes: selecting at least two waypoints from the pool of waypoints; and determining a feasibility metric for the at least two waypoints, wherein determining the feasibility metric includes using a route generation algorithm to generate a route between the at least two waypoints; select a test vehicle from a fleet of test vehicles; and transmit the test order to the test vehicle.

In some aspects, the techniques described herein relate to a method for autonomous vehicle test order generation, the method including: receiving, using at least one processor, a pool of waypoints; generating, using the at least one processor, a test order, wherein generating the test order includes: selecting at least two waypoints from the pool of waypoints; and determining a feasibility metric for the at least two waypoints, wherein determining the feasibility metric includes using a route generation algorithm to generate a route between the at least two waypoints; selecting, using the at least one processor, a test vehicle from a fleet of test vehicles; and transmitting, using the at least one processor, the test order to the test vehicle.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 shows an exemplary embodiment of system for autonomous vehicle test order generation;

FIG. 2 shows an exemplary operational workflow for an autonomous test order orchestrator;

FIGS. 3A and 3B show an exemplary vehicle computing architecture 300;

FIG. 4 shows an exemplary embodiment of a world map;

FIG. 5 shows an exemplary flow diagram of an exemplary method for autonomous vehicle test order generation; and

FIG. 6 shows a diagrammatic representation of an exemplary embodiment of a computing device in the exemplary form of a computer system.

### DETAILED DESCRIPTION

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

As used herein, the term “ratio” refers to a relationship between two numbers (e.g., scores, summations, and the like). Although, ratios can be expressed in a particular order (e.g., a to b or a:b), one of ordinary skill in the art will recognize that the underlying relationship between the numbers can be expressed in any order without losing the significance of the underlying relationship, although observation and correlation of trends based on the ration may need to be reversed. For example, if the values of a over time are (4, 10) and the values of b over time are (2, 4), the ratio a:b will equal (2, 2.5), while the ratio b:a will be (0.5, 0.4). Although the values of a and b are the same in both ratios, the ratios a:b and b: a are inverse and increase and decrease, respectively, over the time period.

### DETAILED DESCRIPTION

The present invention includes in embodiments a system, which may be referred to as an “Autonomous Test Order Orchestrator,” which may generate pseudo-random yet configurable test scenarios.

Furthermore, the present invention in embodiments may include holistic testing of autonomous vehicle systems under conditions that closely approximate real-world operations.

The present invention solves problems experienced with the prior art because it provides a system that significantly enhances quality assurance processes and system reliability. Those and other advantages and benefits of the present invention will become apparent from the detailed description of the invention hereinbelow.

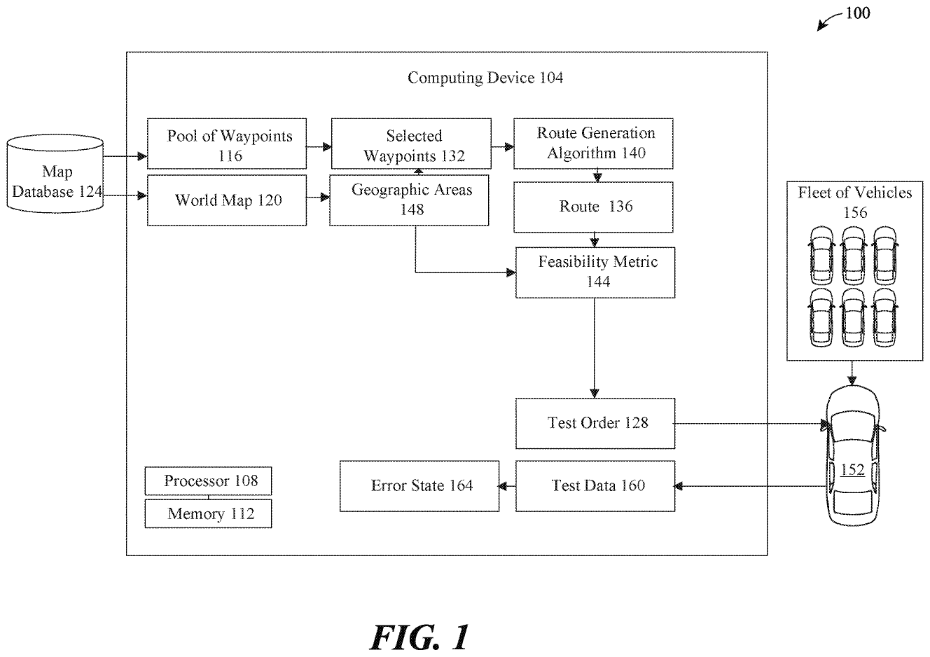

Referring now to FIG. 1, an exemplary embodiment of system 100 for autonomous vehicle test order generation is illustrated. System 100 may include circuitry such as without limitation a processor communicatively connected to a memory; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, system 100 may include at least one processor 108. System 100 may include a memory 112 communicatively connected to the at least one processor 108. The memory 112 may contain instructions configuring the at least one processor 108 to perform one or more actions as described throughout this disclosure.

With continued reference to FIG. 1, memory 112 may include instructions configuring processor 108 to receive a pool of waypoints 116. A “pool of waypoints,” for the purposes of this disclosure, is a collection of locations specified by coordinates. Coordinates may include, as non-limiting examples, latitude and longitude, X and Y coordinates, or X, Y, and Z coordinates. Coordinates may be global or local.

With continued reference to FIG. 1, memory 112 may include instructions configuring processor 108 to receive a world map 120. A “world map,” for the purposes of this disclosure is a digital map of a geographic areas. World map 120 may include a geographic information system (GIS) file. A GIS file (Geographic Information System file) is a structured digital container that stores spatial data. Spatial data includes information about where things are on the within a space. A GIS file may also include descriptive information about what objects are and how they relate to one another.

With continued reference to FIG. 1, the spatial data of GIS file may define the shape and position of features. These features may be represented as points (such as trees or traffic lights), lines (such as roads or rivers), or polygons (such as buildings or lakes). Each geometric object may be stored as a set of coordinates within a defined coordinate reference system. The GIS file may also include an attribute table. This may be structured similarly to a database table or spreadsheet. Each row may correspond to a specific spatial feature; each column may represent a property of that feature. As a non-limiting example, a road feature might include attributes such as name, speed limit, number of lanes, and surface type. As a non-limiting example, building feature might include height, address, and usage classification. The geometry and the attribute table may be linked internally through feature identifiers, allowing GIS software to associate descriptive information with precise spatial locations.

With continued reference to FIG. 1, in some embodiments, GIS files may also store topology. Topology may describes how features relate to one another spatially. Topological information may define connectivity (which roads intersect), adjacency (which polygons share boundaries), and/or containment (which features lie within others).

With continued reference to FIG. 1, GIS files may include one or more data layers. Data layers may include, as non-limiting examples, transportation layers, boundary layers, landmark layers, water feature layers, elevation layers, and satellite imagery layers. In some embodiments, GIS files may include one or more of the forgoing layers.

With continued reference to FIG. 1, memory 112 may include instructions configuring processor 108 to receive. from map database 124, world map 120. Map database 124 may include a plurality of world maps, wherein a specific world map may be retrieved by processor 108. map database 124 may be remote to computing device 104 and communicative with computing device 104 by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local servers or personal computers. A “mesh network” as used in this disclosure is a local network topology in which the infrastructure computing device 104 connect directly, dynamically, and non-hierarchically to as many other computing devices as possible. A “network topology” as used in this disclosure is an arrangement of elements of a communication network. map database 124 may be implemented, without limitation, as a relational database, a key-value retrieval database such as a NOSQL database, or any other format or structure for use as a database that a person skilled in the art would recognize as suitable upon review of the entirety of this disclosure. map database 124 may alternatively or additionally be implemented using a distributed data storage protocol and/or data structure, such as a distributed hash table or the like. map database 124 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In an embodiment, map database 124 may be a generic storage mechanism. A generic storage mechanism may be a storage system or method that is not specific to any particular type or format of data, that is, a storage solution that provides a flexible and adaptable way to store and retrieve data without being tied to a specific data format, schema, or domain.

With continued reference to FIG. 1, pool of waypoints 116 may include any possible point in a city where a vehicle can make a stop. Pool of waypoints 116 may include any possible point in a world map 120 where a vehicle can make a stop. In some embodiments, waypoints 116 may be retrieved from world map 120. In some embodiments, world map 120 may include 100 waypoints 116. In some embodiments, world map 120 may include 1000 waypoints 116. In some embodiments, world map 120 may include 10000 waypoints 116. In some embodiments, world map 120 may include 500 waypoints 116. In some embodiments, world map 120 may include 100-10000 waypoints 116.

With continued reference to FIG. 1, memory 112 may include instructions configuring processor 108 to generate a test order 128. A “test order,” for the purposes of this disclosure, is a command or instruction to be sent to an autonomous vehicle in order to test the autonomous vehicle, the world map, of the autonomous vehicle's systems. As a non-limiting example, test order may instruct the autonomous vehicle to move from a first waypoint to a second waypoint. As a non-limiting example, test order may instruct the autonomous vehicle to stop at a waypoint. As a non-limiting example, test order may instruct that autonomous vehicle to move through or pass by a waypoint on its way to another waypoint.

With continued reference to FIG. 1, generating test order 128 may include selecting one or more selected waypoints 132 from waypoints 116. Selected waypoints 132 are waypoints that have been selected to be part of test order 128 or a feasibility determination. In some embodiments, one or more selected waypoints 132 may include two waypoints. In some embodiments, one or more selected waypoints 132 may include three waypoints. In some embodiments, one or more selected waypoints 132 may include five waypoints. In some embodiments, one or more selected waypoints 132 may include 10 waypoints. In some embodiments, one or more selected waypoints 132 may include 50 waypoints. In some embodiments, one or more selected waypoints 132 may include 100 waypoints. In some embodiments, one or more selected waypoints 132 may include 2-200 waypoints. In some embodiments, one or more selected waypoints 132 may include 2-100 waypoints.

With continued reference to FIG. 1, selecting at least two selected waypoints 132 may include generating random test orders 128 from one waypoint to another waypoint. In some embodiments, one waypoint of selected waypoints 132 may include a pick up waypoints. In some embodiments, one waypoint of selected waypoints 132 may include a drop off waypoint. In some embodiments, one waypoint of selected waypoints 132 may include an intermediate waypoint.

With continued reference to FIG. 1, memory 112 may include instructions configuring processor 108 to generate one or more routes 136 using a route generation algorithm 140. For the route generation algorithm, world map 120 may include or be converted into a graph. The graph may include a plurality of nodes and a plurality of edges. Nodes may represent intersections, roads, or any other paths accessible to a vehicle. Edges may represent road or path segments between the nodes (intersections). For example, an edge may represent a road segment between a first intersection and a second intersection.

With continued reference to FIG. 1, edges may have one or more associated properties. Properties may include, as non-limiting examples, length, speed limits, road types, projected vehicle occupancy, turn restrictions, number of lanes, historical travel time, or the like. In some embodiments, properties may include properties for different times of day. As a non-limiting example, historical travel times may include historical travel times for different times of day.

With continued reference to FIG. 1, each edge may be assigned a cost. A cost is a mathematical representation of a cost of using the edge. As a non-limiting example, a cost for an edge may include a historical travel time. As a non-limiting example, a cost for an edge may include a distance. As a non-limiting example, a cost for an edge may include a projected vehicle occupancy.

With continued reference to FIG. 1, to generate a route 136, memory 112 may include instructions configuring processor 108 to use a graph search algorithm. A graph search algorithm systematically explores connections (i.e. edges) between nodes to find information, uncover patterns, and/or determine optimal paths. For example, graph search algorithm may be configured to traverse the edges (e.g. roads) and nodes (e.g., intersections) to find an optimal or otherwise desired route 136 between selected waypoints 132. In some embodiments, graph search algorithm may be configured to track visited nodes and decide which node to next visit between the unvisited nodes.

With continued reference to FIG. 1, in some embodiments, graph search algorithm may include an informed search algorithm. In some embodiments, graph search algorithm may include an A* (A-star) search. A* may improve speed over a standard graph search algorithm be, for example, using a heuristic to guide the search. The heuristic may include, for example, a straight line distance to the destination. A* may determine which node to progress to based on the formula:

$$f ( n ) = g ( n ) + h ( n )$$

g(n) may represent the cost from a start node to node n. For example, start node may include a current position of a vehicle or a start waypoint. Node n is the current node being evaluated by the algorithm. h(n) may represent an estimated cost, using the heuristic, from node n to the goal. Goal may include the destination for a vehicle. Using this function, A* may determined an estimated cost f(n). Then, A* may move to the node with the lowest f(n) and repeat this process for nodes adjacent to the new node.

With continued reference to FIG. 1, graph search algorithm may include Dijkstra's Algorithm. Dijkstra's algorithm may be configured to expand the unvisited node with the smallest distance from the current node. For each neighbor of the new node, the algorithm may determine a distance comprising the current distance added to the edge weight of the node. If this determined distance is smaller than the neighbor nodes recorded distance, then the algorithm may record that the best path goes through the current node.

With continued reference to FIG. 1, graph search algorithm may be configured to generate routes with the shortest distance. Graph search algorithm may be configured to generate routes with the shortest travel time. Graph search algorithm may be configured to generate routes with the least traffic.

With continued reference to FIG. 1, memory 112 may include instructions configuring processor 108 to determine a feasibility metric 144 for the at least two waypoints. Feasibility metric 144 may be based on map constraints. For example, feasibility metric 144 may measure whether a destination waypoint is reachable from a start waypoint. As a non-limiting example, processor 108 may be configured to take the two waypoints and use internal algorithms to check is a route between them is feasible. Feasibility metric 144 may be used to determine the feasibility of certain pick up and drop off points in map releases for world map 120.

With continued reference to FIG. 1, a first approach to determining feasibility metric 144 may include creating all possible pairs of waypoints. Route generation algorithm 140 may then be run on each pair of waypoints to determine a route 136 between each pair. Pairs that are unreachable from each other (i.e., pairs of waypoints for which routes are unable to be determined) may be filtered out of the test order 128 generation process and/or assigned a negative feasibility metric 144.

With continued reference to FIG. 1, determining feasibility metric 144 may include generating a plurality of pairs of waypoints, wherein generating the plurality of pairs of waypoints comprises matching each waypoint in the pool of waypoints 116 together. Then, processor 108 may be configured to attempt to generate a route 136 between each of the plurality of pairs of waypoints using the route generation algorithm 140. Processor 108 may be configured to determine feasibility metric 144 for each of the plurality of pairs of waypoints as a function of whether route 136 is able to be generated between each of the plurality of pairs of waypoints.

With continued reference to FIG. 1, this first approach to determining feasibility metric 144 may be practical for when there are a lower number of waypoints in pool of waypoints 116. For example, first approach may be practical when there are less than 1000 waypoints in pool of waypoints 116. However, when there are more than 1000 waypoints in pool of waypoints 116, then a different approach, such as the second approach described below, may be desirable.

With continued reference to FIG. 1, a second approach to determining feasibility metric 144 may include using strong connectivity. In some embodiments, pool of waypoints 116 may be slit into a plurality of geographic areas 148 associated with world map 120. In some embodiments, plurality of geographic areas 148 may not be literally tied to specific geographic areas in world map 120; instead plurality of geographic areas 148 may be abstracted as groups of nodes within a graph that are strongly connected to each other. Strongly connected nodes are groups of nodes wherein each node is reachable from every other node in the group of nodes. Then, memory 112 may include instructions configuring processor 108 to

With continued reference to FIG. 1, selecting a first waypoint from a first geographic area of the plurality of geographic areas and a second waypoint from a second geographic areas of the plurality of geographic areas. First geographic area and second geographic area may be a first and second group of strongly connected nodes, respectively. Processor 108 may be configured to attempt to generate a route 136 between the first waypoint and the second waypoint, using, for example, route generation algorithm 140. If a route is able to be generate for first waypoint and second waypoint, then any node within first geographic area must also be reachable from any node within second geographic area. Thus this method may present a technical improvement as it allows for the verification of reachability between a large number of waypoints. Memory 112 may include instructions configuring processor 108 to determine a feasibility metric 144 for the route 136 between the first geographic area and the second geographic areas as a function of whether the route is able to be generated between the first waypoint and the second waypoint. In some embodiments, processor 108 may be configured to repeat this process for routes 136 between each group of strongly connected nodes.

With continued reference to FIG. 1, in some embodiments, for the test order 128 generation process, memory 112 may include instructions configuring processor 108 to filter pool of waypoints 116 as a function of a geometric density of the waypoints. For example, processor 108 may filter out some waypoints where there is a high geometric density of waypoints. In some embodiments, this may occur after feasibility metrics 144 have been determined, so the set of waypoints that have positive feasibility metrics 144 (i.e., are reachable) may be further filtered to exclude some waypoints within areas of high geometric density. For example, this may be beneficial as it allows for test orders 128 to be balanced such that outer lying areas (e.g., suburbs) are also used for training, not just the city center, where the geometric density of waypoints would be expected to be higher.

With continued reference to FIG. 1, in some embodiments, selection of waypoints for test order 128 may be weighted. As a non-limiting example, certain areas of a city or map may be set to be more important than others, thus waypoints from those areas may be weighted such that they are more likely to be selected for test order 128 generation.

With continued reference to FIG. 1, test order 128 may include a first mode of test order, wherein the test order 128 configured a vehicle to stop at every waypoint in test order 128. This may be useful, as a non-limiting example, for testing or improving taxi flow. Test order 128 may include a second mode of test order, wherein the test order 128 configures a vehicle to drive through each waypoint in test order 128. This may be useful, as a non-limiting example, to test or improve autonomous rides or autonomous driving. In some embodiments, a user may configure system 100 to generate test orders using first mode or second mode. In some embodiments, system 100 may randomly choose between first mode and second mode. First mode and second mode are not exclusive modes for generating test order 128 and are not intended to be limiting. Additionally, test order 128 may include portions of an order that include first mode and portions that include second mode.

With continued reference to FIG. 1, memory 112 may include instructions configuring processor 108 to select a test vehicle 152 from a fleet of vehicles 156. In some embodiments, 50% of fleet of vehicles 156 may be designated as available for testing at a given time. In some embodiments, test vehicle 152 may be selected for certain characteristics, such as, as non-limiting examples, hardware versions, software versions, make, model, vehicle type, vehicle dimensions, and the like.

With continued reference to FIG. 1, in some embodiments, test vehicle 152 may be selected so as to enable A/B testing of vehicles within the fleet of vehicles 156. As a non-limiting example, selecting test vehicle 152 may include selecting a first test vehicle running a first autonomous driving software version and selecting a second test vehicle running a second autonomous driving software version. Then these two versions of the autonomous driving software may be A/B tested against each other by observing how the vehicles execute test order 128. As another non-limiting example, selecting test vehicle 152 may include selecting a first test vehicle running a first autonomous driving hardware configuration and selecting a second test vehicle running a second autonomous driving hardware configuration. Then these two versions of the autonomous driving hardware configurations may be A/B tested against each other by observing how the vehicles execute test order 128. For example, if one vehicle has one configuration of cameras and another vehicle has another configuration of cameras, then it is useful to compare the performance of these vehicles on the same test order 128.

With continued reference to FIG. 1, test vehicles 152 may also be selected based on geographic locations. For example, processor 108 may be configured to select test vehicle 152 that are in close proximity with each other. This may further allow the A/B testing methodology as described above as test vehicles 152 that are in close proximity are more likely to encounter similar environments when executing test order 128. For example, first vehicle and second vehicle may be selected such that they are within a geographic threshold distance of each other. The selection of test vehicles 152 to allow for an accomplish effective A/B testing represents a clear technical improvement over the prior art as it allows for different versions of software or different hardware configurations to be tested against each other using automatically generated test orders 128.

With continued reference to FIG. 1, while the description above focuses on selecting two test vehicles 152, a person of ordinary skill in the art, after having reviewed the entity of this disclosure, would appreciate that more than two test vehicles may be chosen for a test order 128 or in some embodiments, more than two configurations (for example, 3-5) of a vehicle may be tested against each other.

With continued reference to FIG. 1, memory 112 may include instructions configuring processor 108 to transmit test order 128 to test vehicle 152. Transmitting test order 128 to test vehicle 152 may include i.transmitting the test order 128 to the first test vehicle. Transmitting test order 128 to test vehicle 152 may include transmitting the test order 128 to the second test vehicle. Transmitting test order 128 to test vehicle 152 may include transmitting the test order 128 to the first and second test vehicle. Transmitting test order 128 to test vehicle 152 may include transmitting the test order 128 any test vehicle chosen for testing. Transmitting test order 128 to test vehicle 152 may include transmitting the test order 128 to the entire fleet of vehicles 156.

With continued reference to FIG. 1, transmitting test order 128 to test vehicle 152 may include using wireless communication. Wireless communication may include, as non-limiting examples, cellular communication, 2G, 3G, 4G, LTE, 5G, EDGE, Radio, line of sight, WiFi, and the like.

With continued reference to FIG. 1, memory 112 may include instructions configuring processor 108 to may be configured to receive test data 160 from test vehicle 152. This may include receiving test data test data 160 using wireless communication. In some embodiments, receiving test data 160 may include using wired communication. Wired communication, as non-limiting examples, may include, ethernet, coax, fiberoptic, USB, or the like. In some embodiments, test vehicle 152 may be configured to offload test data 160 once it has been parked, or is, for example, in storage for the night.

With continued reference to FIG. 1, memory 112 may include instructions configuring processor 108 to detect one or more error states 164 in test data 160. One or more error states 164 may include, as non-limiting examples, a stuck car, a collision, a mechanical fault, an error code, high forces sustained, or the like.

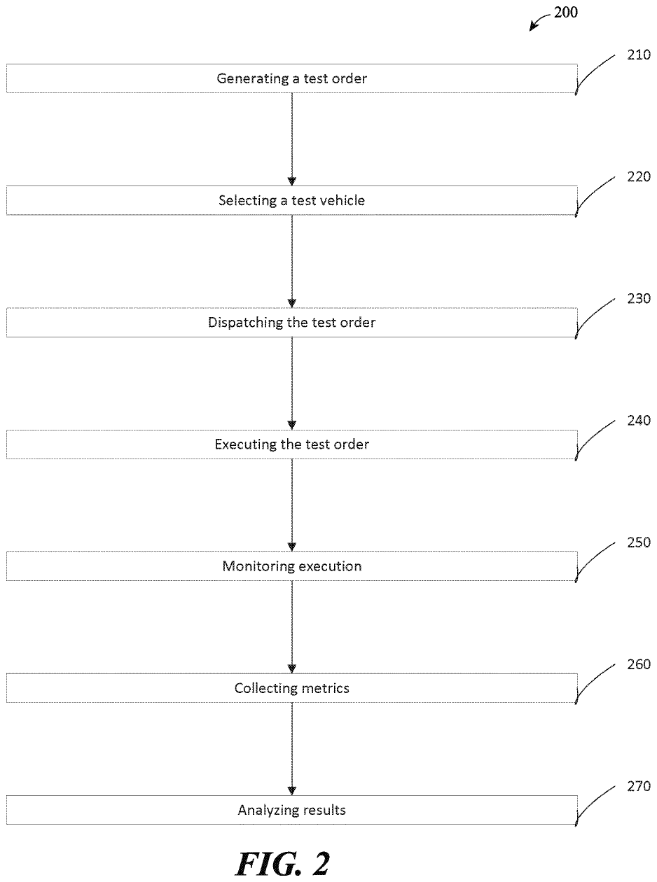

Referring now to FIG. 2, an exemplary operational workflow 200 for an autonomous test order orchestrator is shown. Autonomous test order orchestrator may utilize system 100 as described above. Autonomous test order orchestrator may be configured to perform one or more actions as described above with respect to FIG. 1.

With continued reference to FIG. 2, the operational workflow of the Autonomous Test Order Orchestrator may starts with a step 210 of generating the test order. Generation of the test order may be consistent with generation of 128, described further with reference to FIG. 1.

With continued reference to FIG. 2, the operational workflow of the Autonomous Test Order Orchestrator may include a step 220 of selecting the test vehicle. Selection of the test vehicle may be consistent with selection of test vehicle 152 or test vehicles 152 as described further with reference to FIG. 1.

With continued reference to FIG. 2, the operational workflow of the Autonomous Test Order Orchestrator may then include a step 230 of dispatches the test order. Dispatching the test order may be consistent with transmitting test order 128 to test vehicle 152 as described further with reference to FIG. 1.

With continued reference to FIG. 2, the operational workflow of the Autonomous Test Order Orchestrator may then include a step 240 of executing the test order. Executing the test order may include executing one or more instructions of test order on test vehicle 152. In some embodiments, this may be carried out on test vehicle 152. In some embodiments, executing test order may include causing test vehicle 152 to stop at each waypoint in test order 128. In some embodiments, executing test order may include causing test vehicle 152 to drive through each waypoint in test order 128.

With continued reference to FIG. 2, the operational workflow of the Autonomous Test Order Orchestrator may then include a step 250 of monitoring the execution of test order 128. In some embodiments, test data may be streamed from test vehicle 152 as it completes test order 128 wherein the test data may be used to monitor test vehicle 152.

With continued reference to FIG. 2, the operational workflow of the Autonomous Test Order Orchestrator may then include a step 260 of collecting metrics. Collecting metrics may be consistent with receiving test data 160 as described further with respect to FIG. 1.

With continued reference to FIG. 2, the operational workflow of the Autonomous Test Order Orchestrator may then include a step 270 of analyzing the results of test order 128. This may include detecting error states 164 as described further with respect to FIG. 1.

In some embodiments, the Autonomous Test Order Orchestrator may create simulated passenger orders with randomized yet controllable parameters, dispatches these orders to autonomous vehicles in a test fleet, monitors order execution, and collects performance metrics. This approach may enable testing of the complete service delivery pipeline, including order processing, vehicle dispatch, navigation, passenger interaction protocols, and trip completion procedures.

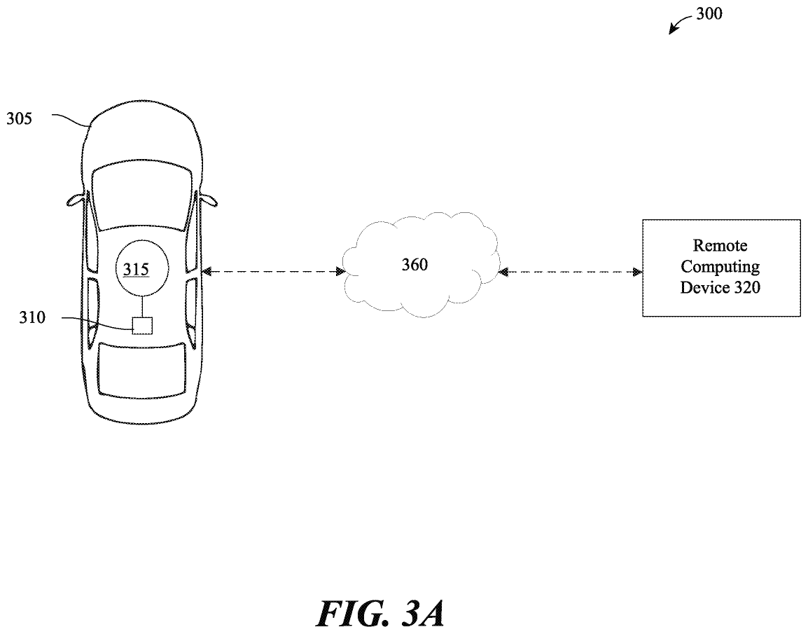

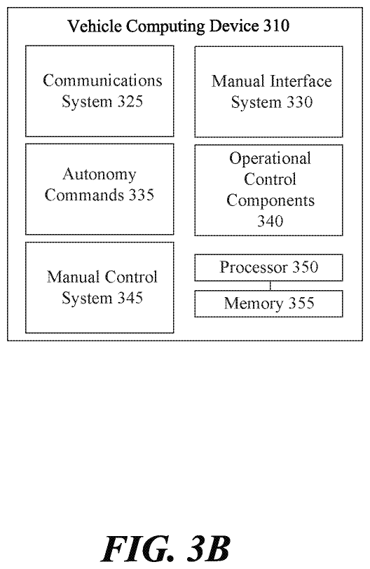

Referring now to FIGS. 3A and 3B, an exemplary vehicle computing architecture 300 is shown. Vehicle computing architecture 300 may include a vehicle 305. A “vehicle,” for the purposes of this disclosure is a device that is designed to transport goods, people, and/or animals. In some embodiments, vehicle 305 may be motorized. As non-limiting examples, vehicle 305 may include a car, a scooter, an ebike, an ATV, a motorcycle, a motorbike, a minibike, a truck, a golf cart, an aircraft, and the like. In some embodiments, vehicle 305 may be human-powered. As non-limiting examples, vehicle 305 may include a bike, a rickshaw, a skateboard, a scooter, or the like.

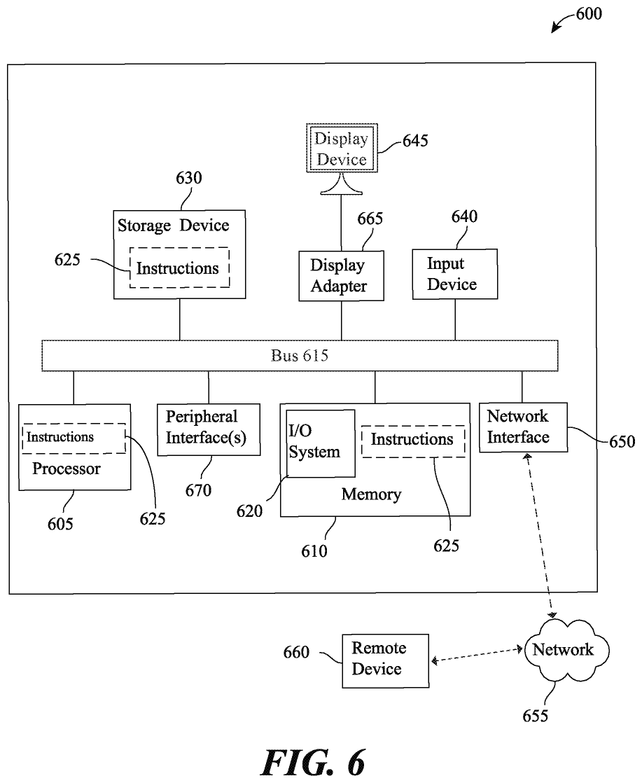

With continued reference to FIGS. 3A AND 3B, the vehicle 305 may be an autonomous vehicle that may drive, navigate, operate, etc. with minimal and/or no interaction from a human driver. Vehicle 305 may include a vehicle computing device 310 that implements a variety of systems on-board the vehicle 305. In some embodiments, vehicle computing device 310 may be consistent with aspects of computing device 600 described further with respect to FIG. 6.

With continued reference to FIGS. 3A and 3B, in some embodiments, vehicle computing architecture 300 may include one or more data acquisition systems 315. A data acquisition systems 315 may include a plurality of sensors configured to detect data from the environment surrounding or inside of vehicle 305. In some embodiments, data acquisition system 315 may include one or more cameras. Cameras may include, as non-limiting examples, wide-angle cameras, high-resolution cameras, panoramic cameras, two-dimensional cameras, three-dimensional cameras, video cameras, and the like. In some embodiments, data acquisition system 315 may include one or more LIDAR sensors. In some embodiments, data acquisition system 315 may include one or more ultrasound sensors. For example, ultrasound sensors may be mounted around the perimeter of vehicle 305. In some embodiments, ultrasound sensors may be located on the corners of vehicle 305. In some embodiments, ultrasound sensors may be used for object detection and/or collision avoidance. In some embodiments, data acquisition system 315 may include one or more microphones. In some embodiments, microphones may be arranged in an array. In some embodiments, microphones may include directional microphones. In some embodiments, microphones may include unidirectional microphones. In some embodiments data acquisition system 315 may include one or more RADAR sensors. In some embodiments, data acquisition system 315 may include, as non-limiting examples, lane detectors, optical readers, electric eyes, and/or other suitable types of image capture devices.

With continued reference to FIGS. 3A and 3B, vehicle computing device 310 may include a plurality of vehicle computing devices 310. As a non-limiting example, in some embodiments, vehicle computing device 310 may include, a central computing device and one or more auxiliary computing devices. In some embodiments, auxiliary computing devices may be located on or in the vehicle 305 roof. In some embodiments, auxiliary computing devices may be located close to certain sensors of data acquisition system 315 that they are configured to process data for. For example, auxiliary computing devices configured to process camera data may be located near cameras. For example, auxiliary computing devices configured to process LIDAR data may be located near LIDAR sensors. This may serve, for example, as an edge computing implementation, wherein, for example, data processing for certain sensors or sources of data may be offloaded to auxiliary computing devices that are closer to the sensors of sources of data of interest. This may beneficially impact data processing as it allows for data to be processed sooner after it is collected.

With continued reference to FIGS. 3A and 3B, the vehicle 305 may be configured to enter into a ready state. The ready state may indicate that the vehicle 305 is ready to operate (and/or return to) an autonomous navigation mode. A computing device on-board the vehicle 305 may be configured to determine whether the vehicle 305 is in the ready state. A remote computing device 320 (e.g., associated with an operations control center) may indicate that the vehicle 305 is ready to begin and/or resume autonomous navigation.

With continued reference to FIGS. 3A and 3B, for instance, the vehicle computing system 310 may include a communications system 325, one or more manual interface systems 330, one or more data acquisition systems 315, an autonomy command 335, one or more operational control components 340, and/or a manual control system 345.

With continued reference to FIGS. 3A and 3B, the manual interface systems 330 may be configured to allow interaction between a user (e.g., human) and the vehicle 305 (e.g., the vehicle computing system 310). The manual interface systems 330 may include a variety of interfaces for the user to input and/or receive information from the vehicle computing system 310. The manual interface systems 330 may include one or more input device(s) (e.g., touchscreens, keypad, touchpad, knobs, buttons, sliders, switches, mouse, gyroscope, microphone, other hardware interfaces) configured to receive user input. The manual interface systems 330 may include a user interface (e.g., graphical user interface, conversational and/or voice interfaces, chatter robot, gesture interface, other interface types) for receiving user input.

With continued reference to FIGS. 3A and 3B, vehicle computing system 310 may include a processor 350 and a memory 355. Processor 350 and memory 355 may be consistent with other processors and memory described throughout this disclosure. Processor 350 and memory 355 may be communicatively connected. Memory 355 may contain instructions (e.g., software) configured to cause processor 350 to perform one or more actions in accordance with this disclosure.

With continued reference to FIGS. 3A and 3B, vehicle computing architecture 300 may include a remote computing device 320. the remote computing device 320 may include and/or otherwise be associated with one or more computing devices (e.g., computing device 600, referred to in FIG. 6) that are remote from the vehicle 305. The remote computing device 320 may communicate with the vehicle 305 via one or more communications networks 360. The communications network 360 may include various wired and/or wireless communication mechanisms (e.g., cellular, wireless, satellite, microwave, and radio frequency) and/or any desired network topology. For example, the communications network 360 may include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 305.

With continued reference to FIGS. 3A and 3B, actions described throughout this disclosure may be configured to run locally, or in the cloud. For example, computing device 104 may be located in the cloud. In other embodiments, actions described for computing device 104 may be performed locally on vehicle computing device 310. In some embodiments, actions and tasks described for computing device 104 may be performed both locally and in the cloud, for example, using a distributed architecture.

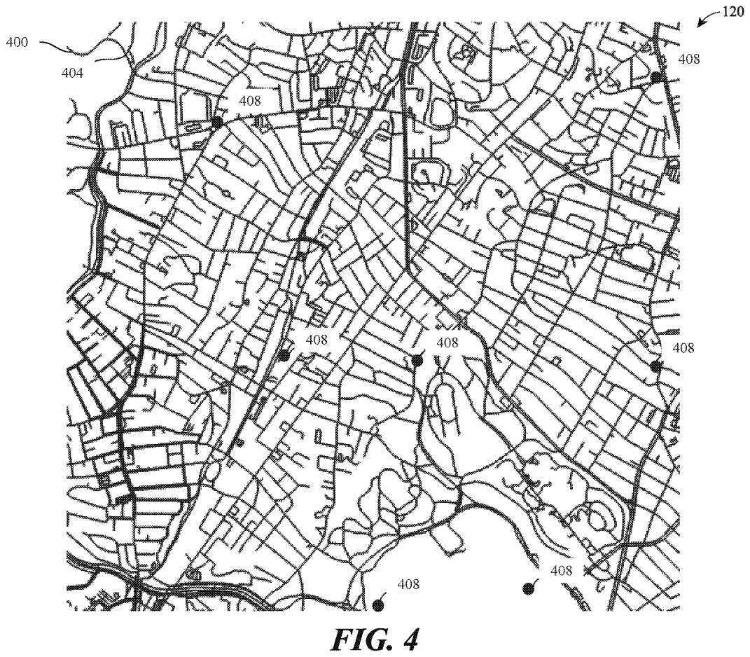

Referring now to FIG. 4, an exemplary embodiment of a world map 120 is shown. World map 120, as shown, may be a visual representation of world map 120. World map 120 may be a data structure and/or a network of nodes and edges. World map 120 may include one or more roads 400. Roads 400 may include, as non-limiting examples, roads, streets, paths, bike paths, sidewalks, walking paths, alleys, highways, boulevards, turnpikes, parkways, driveways, parking lots, and the like. Roads 400 may be signified using lines on world map 120. In a data structure, roads 400 may be edges, while intersections between roads 400 may be nodes. World map 120 includes intersections 404. Intersections 404 are where one or more roads 400 meet. World map 120 may include a plurality of waypoints 408. Waypoints 408 may be consistent with waypoints as described with respect to FIG. 1.

The systems and methods described in this disclosure may be allow for AB testing of different software, cars, sensor sets, or the like. For example, in some embodiments, a route may be generated and sent to cars with different software. Therefore, the software (or other different parameter) may be AB tested. In some embodiments, systems and methods described herein may validate new world maps. For examples, routes may be generated between waypoints within a pool of waypoints in order to test said waypoints. This may include a map regression check. This is otherwise not possible without such system (unless you ride over the whole map in real car). This saves a lot of time, and allows for validation scale easily (this may be because you don't need to spend time on testing in real world for every new map version) and therefore deliver map updates faster.

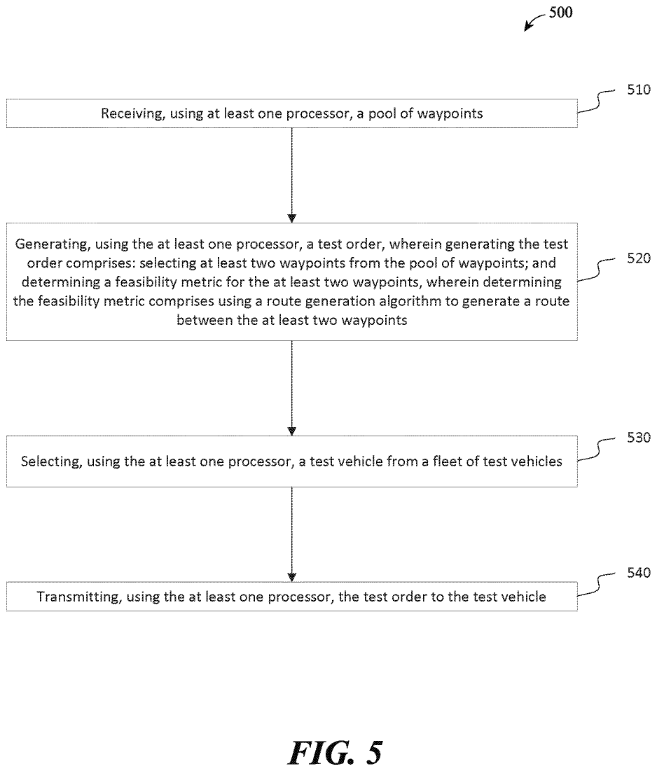

Referring now to FIG. 5, an exemplary flow diagram of an exemplary method 500 for autonomous vehicle test order generation is shown. Method 500 includes a step 510 of receiving, using at least one processor, a pool of waypoints. This may be performed, without limitation, as described with reference to any of FIGS. 1-4.

Referring to FIG. 5, method 500 includes a step 520 of generating, using the at least one processor, a test order. Generating the test order may include: selecting at least two waypoints from the pool of waypoints; and determining a feasibility metric for the at least two waypoints, wherein determining the feasibility metric includes using a route generation algorithm to generate a route between the at least two waypoints. This may be performed, without limitation, as described with reference to any of FIGS. 1-4.

Referring to FIG. 5, method 500 includes a step 530 of selecting, using the at least one processor, a test vehicle from a fleet of test vehicles. This may be performed, without limitation, as described with reference to any of FIGS. 1-4.

Referring to FIG. 5, method 500 includes a step 540 of transmitting, using the at least one processor, the test order to the test vehicle. This may be performed, without limitation, as described with reference to any of FIGS. 1-4.

In some aspects, the techniques described herein relate to a method, wherein determining the feasibility metric includes: generating a plurality of pairs of waypoints, wherein generating the plurality of pairs of waypoints includes matching each waypoint in the pool of waypoints together; attempting to generate a route between each of the plurality of pairs of waypoints using the route generation algorithm; and determining the feasibility metric for each of the plurality of pairs of waypoints as a function of whether the route is able to be generated between each of the plurality of pairs of waypoints.

In some aspects, the techniques described herein relate to a method, wherein: the method further includes receiving, using the at least one processor, from a map database, a world map; and using the route generation algorithm to generate a route between the at least two waypoints is a function of a plurality of constraints of the world map.

In some aspects, the techniques described herein relate to a method, wherein determining the feasibility metric includes: receiving, from a map database, a world map; splitting the pool of waypoints into a plurality of geographic areas associated with the world map, wherein the plurality of geographic areas are non-overlapping; selecting a first waypoint from a first geographic area of the plurality of geographic areas and a second waypoint from a second geographic areas of the plurality of geographic areas; attempting to generate a route between the first waypoint and the second waypoint; and determining a feasibility metric for the route between the first geographic area and the second geographic areas as a function of whether the route is able to be generated between the first waypoint and the second waypoint.

In some aspects, the techniques described herein relate to a method, wherein selecting a test vehicle from a fleet of test vehicles includes: selecting a first test vehicle running a first autonomous driving software version; and selecting a second test vehicle running a second autonomous driving software version.

In some aspects, the techniques described herein relate to a method, wherein transmitting the test order to the test vehicle includes: transmitting the test order to the first test vehicle; and transmitting the test order to the second test vehicle.

In some aspects, the techniques described herein relate to a method, wherein selecting a test vehicle from a fleet of test vehicles includes: selecting a first test vehicle running a first autonomous driving software version; and selecting a second test vehicle running a second autonomous driving software version, wherein the first test vehicle and the second test vehicle are also selected as a function of their geographic locations such that the first test vehicle and the second test vehicle are within a set distance of each other.

In some aspects, the techniques described herein relate to a method, wherein: selecting a test vehicle from a fleet of test vehicles includes: selecting a first test vehicle running a first autonomous driving hardware configuration; and selecting a second test vehicle running a second autonomous driving hardware configuration; and transmitting the test order to the test vehicle includes: transmitting the test order to the first test vehicle; and transmitting the test order to the second test vehicle.

In some aspects, the techniques described herein relate to a method, further including: receiving, using the at least one processor, test data from the test vehicle; and detecting, using the at least one processor, one or more error states in the test data.

In some aspects, the techniques described herein relate to a method, wherein receiving the pool of waypoints includes filtering the pool of waypoints as a function of a geometric density of the waypoints.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 605 and a memory 610 that communicate with each other, and with other components, via a bus 615. Bus 615 may include any of several types of bus structures including, but not limited to, a memory bus, a memory controller, a peripheral bus, a local bus, and any combinations thereof, using any of a variety of bus architectures.

Processor 605 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 605 may be organized according to Von Neumann and/or Harvard architecture as a non-limiting example. Processor 605 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 610 may include various components (e.g., machine-readable media) including, but not limited to, a random-access memory component, a read only component, and any combinations thereof. In one example, a basic input/output system 620 (BIOS), including basic routines that help to transfer information between elements within computer system 600, such as during start-up, may be stored in memory 610. Memory 610 may also include (e.g., stored on one or more machine-readable media) instructions (e.g., software) 625 embodying any one or more of the aspects and/or methodologies of the present disclosure. In another example, memory 610 may further include any number of program modules including, but not limited to, an operating system, one or more application programs, other program modules, program data, and any combinations thereof. Memory 610 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 600 may also include a storage device 630. Examples of a storage device (e.g., storage device 630) include, but are not limited to, a hard disk drive, a magnetic disk drive, an optical disc drive in combination with an optical medium, a solid-state memory device, and any combinations thereof. Storage device 630 may be connected to bus 615 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 630 (or one or more components thereof) may be removably interfaced with computer system 600 (e.g., via an external port connector (not shown)). Particularly, storage device 630 and an associated machine-readable medium may provide nonvolatile and/or volatile storage of machine-readable instructions, data structures, program modules, and/or other data for computer system 600. In some embodiments, storage device 630 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software (e.g., instructions 625) may reside, completely or partially, within machine-readable medium. In another example, software may reside, completely or partially, within processor 605.

Computer system 600 may also include an input device 640. In one example, a user of computer system 600 may enter commands and/or other information into computer system 600 via input device 640. Examples of an input device 640 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 640 may be interfaced to bus 615 via any of a variety of interfaces (not shown) including, but not limited to, a serial interface, a parallel interface, a game port, a USB interface, a FIREWIRE interface, a direct interface to bus 615, and any combinations thereof. Input device 640 may include a touch screen interface that may be a part of or separate from display 645, discussed further below. Input device 640 may be utilized as a user selection device for selecting one or more graphical representations in a graphical interface as described above.

A user may also input commands and/or other information to computer system 600 via storage device 630 (e.g., a removable disk drive, a flash drive, etc.) and/or network interface device 650. A network interface device, such as network interface device 650, may be utilized for connecting computer system 600 to one or more of a variety of networks, such as network 655, and one or more remote devices 660 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 655, may employ a wired and/or a wireless mode of communication. In general, any network topology may be used. Information (e.g., data, software, etc.) may be communicated to and/or from computer system 600 via network interface device 650.

Computer system 600 may further include a video display adapter 665 for communicating a displayable image to a display device, such as display 645. Examples of a display device include, but are not limited to, a liquid crystal display (LCD), a cathode ray tube (CRT), a plasma display, a light emitting diode (LED) display, and any combinations thereof. Display adapter 665 and display 645 may be utilized in combination with processor 605 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 615 via a peripheral interface 670. Examples of a peripheral interface include, but are not limited to, a serial port, a USB connection, a FIREWIRE connection, a parallel connection, and any combinations thereof.

Further referring to FIG. 6, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 6, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 6, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 600, processor 605, and memory 610 may be virtualized; that is, a virtual machine and/or container may interact directly with such computing system 600, processor 605, and/or memory 610, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 605 comprises a plurality of processors and/or processor cores, virtualization may, in some cases, simulate or emulate a single (virtual) processor whose functions are allocated to one or more of the plurality of processors and/or processor cores. In this case, while processor 605 may be said to be virtualized, the processor 605, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, as discussed above, it should be understood that the particular methods and systems used to implement the disclosure may be modified without changing the spirit of the disclosure and as such the various art-recognized alternatives are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. A system for autonomous vehicle test order generation, the system comprising:
at least one processor; and
a memory communicatively connected to the at least one processor, the memory containing instructions configuring the at least one processor to:
receive a pool of waypoints;
generate a test order, wherein generating the test order comprises:
selecting at least two waypoints from the pool of waypoints; and
determining a feasibility metric for the at least two waypoints, wherein determining the feasibility metric comprises using a route generation algorithm to generate a route between the at least two waypoints;
select a test vehicle from a fleet of test vehicles; and
transmit the test order to the test vehicle.

2. The system of claim 1, wherein determining the feasibility metric comprises:
generating a plurality of pairs of waypoints, wherein generating the plurality of pairs of waypoints comprises matching each waypoint in the pool of waypoints together;
attempting to generate a route between each of the plurality of pairs of waypoints using the route generation algorithm; and
determining the feasibility metric for each of the plurality of pairs of waypoints as a function of whether the route is able to be generated between each of the plurality of pairs of waypoints.

3. The system of claim 1, wherein:
the memory contains instructions further configuring the at least one processor to receive from map database, a world map; and
using the route generation algorithm to generate a route between the at least two waypoints is a function of a plurality of constraints of the world map.

4. The system of claim 1, wherein determining the feasibility metric comprises:
receiving, from a map database, a world map;
splitting the pool of waypoints into a plurality of geographic areas associated with the world map, wherein the plurality of geographic areas are non-overlapping;
selecting a first waypoint from a first geographic area of the plurality of geographic areas and a second waypoint from a second geographic areas of the plurality of geographic areas;
attempting to generate a route between the first waypoint and the second waypoint; and
determining a feasibility metric for the route between the first geographic area and the second geographic areas as a function of whether the route is able to be generated between the first waypoint and the second waypoint.

5. The system of claim 1, wherein selecting a test vehicle from a fleet of test vehicles comprises:
selecting a first test vehicle running a first autonomous driving software version; and
selecting a second test vehicle running a second autonomous driving software version.

6. The system of claim 5, wherein transmitting the test order to the test vehicle comprises:
transmitting the test order to the first test vehicle; and
transmitting the test order to the second test vehicle.

7. The system of claim 1, wherein selecting a test vehicle from a fleet of test vehicles comprises:
selecting a first test vehicle running a first autonomous driving software version; and
selecting a second test vehicle running a second autonomous driving software version, wherein the first test vehicle and the second test vehicle are also selected as a function of their geographic locations such that the first test vehicle and the second test vehicle are within a set distance of each other.

8. The system of claim 1, wherein:
selecting a test vehicle from a fleet of test vehicles comprises:
selecting a first test vehicle running a first autonomous driving hardware configuration; and
selecting a second test vehicle running a second autonomous driving hardware configuration; and
transmitting the test order to the test vehicle comprises:
transmitting the test order to the first test vehicle; and
transmitting the test order to the second test vehicle.

9. The system of claim 1, wherein the memory contains instructions further configuring the at least one processor to:
receive test data from the test vehicle; and
detect one or more error states in the test data.

10. The system of claim 1, wherein receiving the pool of waypoints comprises filtering the pool of waypoints as a function of a geometric density of the waypoints.

11. A method for autonomous vehicle test order generation, the method comprising:
receiving, using at least one processor, a pool of waypoints;
generating, using the at least one processor, a test order, wherein generating the test order comprises:
selecting at least two waypoints from the pool of waypoints; and
determining a feasibility metric for the at least two waypoints, wherein
determining the feasibility metric comprises using a route generation
algorithm to generate a route between the at least two waypoints;
selecting, using the at least one processor, a test vehicle from a fleet of test vehicles; and
transmitting, using the at least one processor, the test order to the test vehicle.

12. The method of claim 11, wherein determining the feasibility metric comprises:
generating a plurality of pairs of waypoints, wherein generating the plurality of pairs of waypoints comprises matching each waypoint in the pool of waypoints together;
attempting to generate a route between each of the plurality of pairs of waypoints using the route generation algorithm; and
determining the feasibility metric for each of the plurality of pairs of waypoints as a function of whether the route is able to be generated between each of the plurality of pairs of waypoints.

13. The method of claim 11, wherein:
the method further comprises receiving, using the at least one processor, from a map database, a world map; and
using the route generation algorithm to generate a route between the at least two waypoints is a function of a plurality of constraints of the world map.

14. The method of claim 11, wherein determining the feasibility metric comprises:
receiving, from a map database, a world map;
splitting the pool of waypoints into a plurality of geographic areas associated with the world map, wherein the plurality of geographic areas are non-overlapping;
selecting a first waypoint from a first geographic area of the plurality of geographic areas and a second waypoint from a second geographic areas of the plurality of geographic areas;
attempting to generate a route between the first waypoint and the second waypoint; and
determining a feasibility metric for the route between the first geographic area and the second geographic areas as a function of whether the route is able to be generated between the first waypoint and the second waypoint.

15. The method of claim 11, wherein selecting a test vehicle from a fleet of test vehicles comprises:
selecting a first test vehicle running a first autonomous driving software version; and
selecting a second test vehicle running a second autonomous driving software version.

16. The method of claim 15, wherein transmitting the test order to the test vehicle comprises:
transmitting the test order to the first test vehicle; and
transmitting the test order to the second test vehicle.

17. The method of claim 11, wherein selecting a test vehicle from a fleet of test vehicles comprises:
selecting a first test vehicle running a first autonomous driving software version; and
selecting a second test vehicle running a second autonomous driving software version, wherein the first test vehicle and the second test vehicle are also selected as a function of their geographic locations such that the first test vehicle and the second test vehicle are within a set distance of each other.

18. The method of claim 11, wherein:
selecting a test vehicle from a fleet of test vehicles comprises:
selecting a first test vehicle running a first autonomous driving hardware configuration; and
selecting a second test vehicle running a second autonomous driving hardware configuration; and
transmitting the test order to the test vehicle comprises:
transmitting the test order to the first test vehicle; and
transmitting the test order to the second test vehicle.

19. The method of claim 11, further comprising:
receiving, using the at least one processor, test data from the test vehicle; and
detecting, using the at least one processor, one or more error states in the test data.

20. The method of claim 11, wherein receiving the pool of waypoints comprises filtering the pool of waypoints as a function of a geometric density of the waypoints.
